(19) United States
(12) Patent Application Publication
(10) Pub. No.: US 2026/0278046 A1
(43) Pub. Date: Sep. 17, 2026

(54) JOB EXECUTION APPARATUS, JOB EXECUTION METHOD, AND STORAGE MEDIUM

(71) Applicant: Konica Minolta, Inc., Tokyo (JP)

(72) Inventor: Takashi Sugaya, Tokyo (JP)

(73) Assignee: Konica Minolta, Inc., Tokyo (JP)

(21) Appl. No.: 19/563,266

(22) Filed: Mar. 11, 2026

(30) Foreign Application Priority Data
Mar. 13, 2025 (JP) 2025-040377

(51) Int. Cl. G06F 21/30; G06F 9/30

(52) U.S. Cl. CPC G06F 21/30; G06F 9/30

(57) ABSTRACT

A job execution apparatus includes a hardware processor that: receives an execution instruction of a job submitted from an external device; determines, based on a time from submission of the job from the external device to reception of a first input from a user, the first input leading to the execution instruction of the job, whether authentication based on a second input from the user is required; and executes the job based on the received execution instruction of the job. When determining that the authentication is required, the hardware processor executes the job after executing the authentication. When determining that the authentication is not required, the hardware processor executes the job without executing the authentication.

### CROSS-REFERENCE TO RELATED APPLICATION

The entire disclosure of Japanese Patent Application No. 2025-040377 filed on Mar. 13, 2025, is incorporated herein by reference in its entirety.

### BACKGROUND OF THE INVENTION

### Technical Field

The present disclosure relates to a job execution apparatus, a job execution method, and a storage medium.

### Description of Related Art

Conventionally, from the viewpoint of security, an image forming apparatus having a device authentication (MFP authentication) function is known. When performing printing from his/her own PC, each user who uses the above-described image forming apparatus enters, on a printer driver, an ID/password registered in the image forming apparatus or sets a PIN code. In this case, each user moves to the image forming apparatus and enters an ID/password to log in or enters a PIN code of a print job submitted by the user on a job list. When user authentication is successful, the image forming apparatus executes the print job. Thus, each user can reliably receive the printed material obtained by executing the print job submitted by the user without it being intercepted.

As an image forming apparatus having a device authentication function, for example, Japanese Unexamined Patent Application Publication No. 2020-75497 discloses a configuration in which, when a wait occurs during execution of another print job, a user is notified that printing can be performed after completion of the other print job.

Furthermore, Japanese Unexamined Patent Application Publication No. 2015-22674 discloses a configuration in which, when a user has a prior authentication record and that authentication record is within its validity period, user authentication in the image forming apparatus is omitted.

### SUMMARY OF THE INVENTION

However, although the above-described authentication configuration is necessary for safe use of the image forming apparatus, it is necessary to enter authentication information at the time of printing, which is troublesome. For example, the configuration described in Japanese Unexamined Patent Application Publication No. 2020-75497 is to notify a device used by the user, when another print job is being executed and the user cannot log in, that printing is possible after printing (login) becomes possible. That is, the configuration described in Japanese Unexamined Patent Application Publication No. 2020-75497 can suppress the occurrence of a waiting time related to the login of the user and forgetting of printing but cannot omit input of authentication information.

Furthermore, the configuration described in Japanese Unexamined Patent Application Publication No. 2015-22674 is a configuration in which omission of user authentication is permitted based on past authentication records. However, in the configuration described in Japanese Unexamined Patent Application Publication No. 2015-22674, when the user has no past authentication record, user authentication cannot be omitted. In particular, in the configuration described in Japanese Unexamined Patent Application Publication No. 2015-22674, when a user seeking the convenience of skipping authentication has no past authentication record, user authentication cannot be omitted, causing inconvenience.

An object of the present disclosure is to provide a job execution apparatus, a job execution method, and a storage medium capable of both assuring security and improving convenience by dynamically changing the necessity of user authentication.

To achieve at least one of the abovementioned objects, a job execution apparatus reflecting one aspect of the present invention comprises a hardware processor that: receives an execution instruction of a job submitted from an external device; determines, based on a time from submission of the job from the external device to reception of a first input from a user, the first input leading to the execution instruction of the job, whether authentication based on a second input from the user is required; and executes the job based on the received execution instruction of the job, wherein, when determining that the authentication is required, the hardware processor executes the job after executing the authentication, and, when determining that the authentication is not required, the hardware processor executes the job without executing the authentication.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming system according to the present embodiment;

FIG. 2 is a functional block diagram illustrating a control structure of a terminal device;

FIG. 3 is a diagram illustrating a schematic configuration of an image forming apparatus;

FIG. 4 is a functional block diagram illustrating a control structure of the image forming apparatus;

FIG. 5 is a flowchart illustrating an example of control of the image forming system according to the present embodiment;

FIG. 6 is a view illustrating an example of an authentication screen;

FIG. 7 is a diagram illustrating an example of a table in which a first predetermined time is set for each user;

FIG. 8 is a diagram illustrating an example of the authentication screen on which a job confirmation button is newly displayed;

FIG. 9 is a view illustrating an example of a home screen;

FIG. 10 is a view illustrating an example of a job execution screen;

FIG. 11 is a view illustrating an example of a PIN code input screen;

FIG. 12 is a flowchart illustrating an example of control of an image forming system according to Modification Example 2; and

FIG. 13 is a flowchart illustrating an example of control of an image forming system according to Modification Example 3.

### DETAILED DESCRIPTION

Hereinafter, one or more embodiments of the present invention will be described with reference to the drawings. However, the scope of the invention is not limited to the disclosed embodiments.

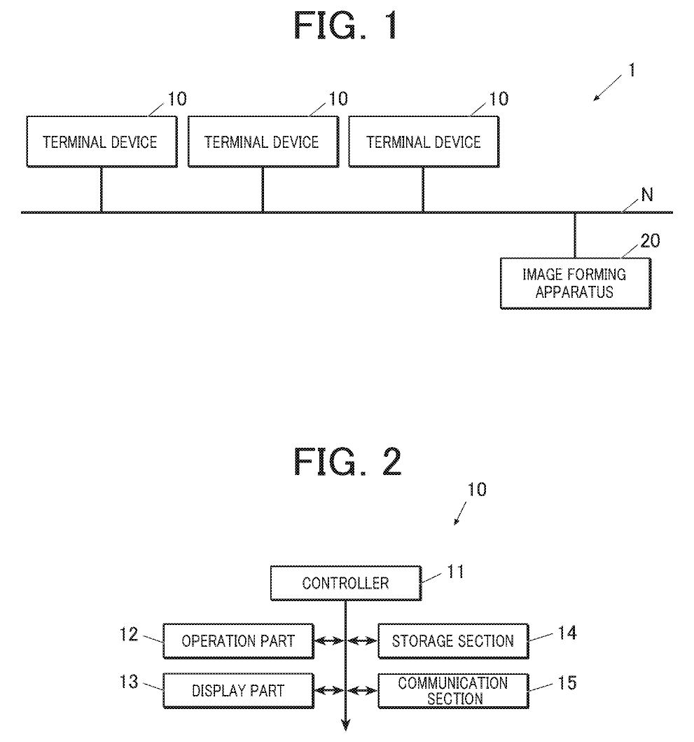

As illustrated in FIG. 1, an image forming system 1 according to the present embodiment includes a plurality of terminal devices 10 and an image forming apparatus 20 as a job execution apparatus of the present disclosure. Each device constituting the image forming system 1 is connected to a communication network N. The communication network N is, specifically, a local area network (LAN), a wide area network (WAN), the Internet, or the like.

Each of the terminal devices (external devices) 10 is a stationary terminal device, such as a desktop PC or a notebook PC, used by each user who belongs to an organization in which the image forming system 1 is introduced. The terminal device 10 manages a print job (hereinafter, may be simply referred to as a job) for forming an image on a sheet using the image forming apparatus 20. The terminal device 10 mutually communicates with the image forming apparatus 20 using the communication network N. The terminal device 10 submits a job including print data to be printed to the image forming apparatus 20 via a printer driver.

As illustrated in FIG. 2, the terminal device 10 includes a controller 11, an operation part 12, a display part 13, a storage section 14, and a communication section 15.

The controller 11 centrally controls the operation of the terminal device 10. Specifically, the controller 11 includes a CPU, a ROM, a RAM, and the like. The controller 11 integrally controls each component of the terminal device 10 in cooperation with program data loaded in the work area of the RAM and the CPU. The program data is stored in the ROM or the storage section 14.

The operation part 12 includes, for example, a keyboard having character input keys, number input keys, and the like, and a pointing device such as a mouse. The operation part 12 receives an operation input by the user and outputs an operation signal corresponding to the operation input to the controller 11. The operation part 12 may be, for example, a touch screen integrally formed with the display part 13.

The display part 13 includes, for example, a display such as an LCD. The display part 13 displays an image based on a display control signal output from the controller 11 on a display screen.

The storage section 14 includes, for example, an HDD and a semiconductor memory. The storage section 14 stores data such as program data and various setting data so that the controller 11 can read and write the data.

The communication section 15 is a communication interface including a communication IC and a communication connector. The communication section 15 performs data communication via the communication network N using a predetermined communication protocol under the control of the controller 11. For example, the communication section 15 submits (transmits) a job including print data to be printed to the image forming apparatus 20 via the communication network N.

The image forming apparatus 20 is an apparatus that forms an image on a sheet based on print data.

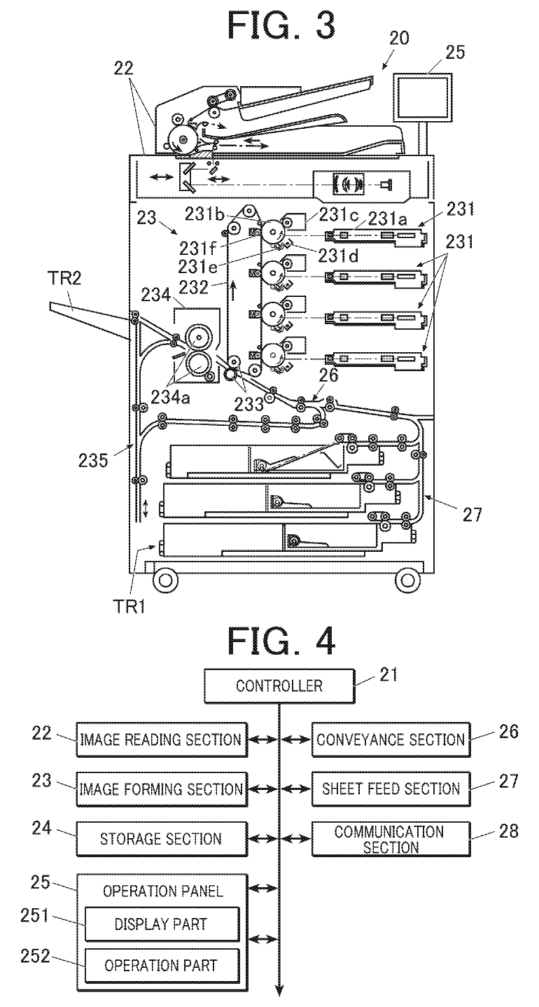

As illustrated in FIGS. 3 and 4, the image forming apparatus 20 includes a controller (hardware processor) 21, an image reading section 22, an image forming section 23, a storage section 24, an operation panel 25, a conveyance section 26, a sheet feed section 27, and a communication section 28.

The controller 21 includes a CPU, a RAM, a ROM, and the like. First, in response to various signals, the CPU reads various programs stored in the ROM and loads them into the RAM. The various signals include an operation signal input from the operation part 252, and an instruction signal received by the communication section 28. Next, the CPU comprehensively controls the operation of the image forming apparatus 20 in cooperation with the various programs loaded in the RAM.

First, the image reading section 22 scans and exposes an image of a document placed on a document plate or an automatic document feeder (ADF) with an optical system of a scanning exposure device. Next, the image reading section 22 reads the reflected light with a line image sensor to obtain an image signal. The image signal is subjected to processing such as A/D conversion, shading correction, and compression, and is then input as image data to the controller 21.

The image forming section 23 forms an image on a sheet by an electrophotographic method based on print data. The print data is image data read by the image reading section 22 or image data included in a job received from the terminal device 10. The image forming section 23 forms an image of four colors of C, M, Y, and K on a sheet, according to the pixel values of the four colors of each pixel of the image data. The image forming section 23 includes four writing sections 231, an intermediate transfer belt 232, secondary transfer rollers 233, and a fixing section 234.

The four writing sections 231 are arranged in series (tandem) along the belt surface of the intermediate transfer belt 232 to form images in C, M, Y and K colors. The writing sections 231 have the same configuration except that they form images in different colors. Each of the writing sections 231 includes an optical scanning section 231a, a photoreceptor 231b, a developing section 231c, a charging section 231d, a cleaning section 231e, and a primary transfer roller 231f.

In image formation, first, each writing section 231 causes the charging section 231d to charge the photoreceptor 231b. Next, the writing section 231 scans the photoreceptor 231b with a light beam emitted from the optical scanning section 231a based on the image data, thereby forming an electrostatic latent image. Next, the writing section 231 causes the developing section 231c to supply toner and develop an image. Thus, an image (a monochromatic toner image) is formed on the photoreceptor 231b.

Next, the writing sections 231 cause the respective primary transfer rollers 231f to primarily transfer the respective images formed on the respective photoreceptors 231b onto the intermediate transfer belt 232 in a sequentially superimposed manner. Thus, an image of the four colors (color toner image) is formed on the intermediate transfer belt 232. Next, each of the writing sections 231 causes the cleaning section 231e to remove the toner remaining on the photoreceptor 231b.

In the image forming section 23, a sheet is fed from a sheet feed tray TR1 in accordance with the timing at which the image on the rotating intermediate transfer belt 232 reaches the position of the secondary transfer rollers 233. One of the paired secondary transfer rollers 233 comes into pressure contact with the intermediate transfer belt 232, and the other constitutes one of a plurality of rollers around which the intermediate transfer belt 232 is wound. Next, the image forming section 23 secondarily transfers the image (color toner image) from the intermediate transfer belt 232 onto a sheet by pressure contact of the secondary transfer roller 233. Next, the image forming section 23 conveys the sheet to the fixing section 234 to subject the sheet to fixing processing. The fixing processing is processing in which the fixing roller 234a applies heat and pressure to the sheet to fix the image on the sheet. When forming images on both sides of a sheet, the image forming section 23 conveys the sheet to a reversing path 235 to reverse the side of the sheet and then feeds the sheet again to the position of the secondary transfer rollers 233.

The storage section 24 is a nonvolatile storage means including an HDD, an SSD, or the like. The storage section 24 stores various programs, various kinds of setting data, and the like so as to be readable and writable by the controller 21.

The operation panel 25 includes a display part 251 that displays various information for the user and an operation part 252 that receives an operation input from the user.

The display part 251 includes a color liquid crystal display or the like. The display part 251 displays an operation screen and the like (various setting screens, various buttons, an operating status of each function, and the like) according to a display control signal input from the controller 21.

The operation part 252 includes a touch screen provided on the screen of the display part 251 and various hard keys arranged around the screen of the display part 251. When a button displayed on the screen is pressed with a finger, a stylus, or the like, the operation part 252 first detects the coordinates of the pressed position in terms of voltage values. Next, the operation part 252 outputs an operation signal associated with the detected position to the controller 21. Note that the touch screen is not limited to a pressure-sensitive type, but may be, for example, an electrostatic type, an optical type, or the like. When a hard key is pressed, the operation part 252 outputs an operation signal associated with the pressed key to the controller 21.

The conveyance section 26 includes a plurality of roller pairs. The conveyance section 26 conveys a sheet supplied from the sheet feed section 27 to the image forming section 23 and ejects the sheet on which an image has been formed by the image forming section 23 to the sheet ejection tray TR2.

The sheet feed section 27 includes a plurality of sheet feed trays TR1 and feeds sheets from the sheet feed trays TR1 to the image forming section 23. Each of the sheet feed trays TR1 stores sheets of a paper type and size predetermined for the sheet feed tray TR1.

The communication section 28 is an interface that includes a communication IC, a communication connector, and the like and connects the image forming apparatus 20 to the communication network N. Under the control of the controller 21, the communication section 28 transmits and receives various kinds of information to and from the terminal device 10 connected to the communication network N using a predetermined communication protocol. Note that the communication section 28 can also input and output various kinds of information via USB. For example, the communication section 28 receives a job including print data to be printed transmitted from the terminal device 10 via the communication network N.

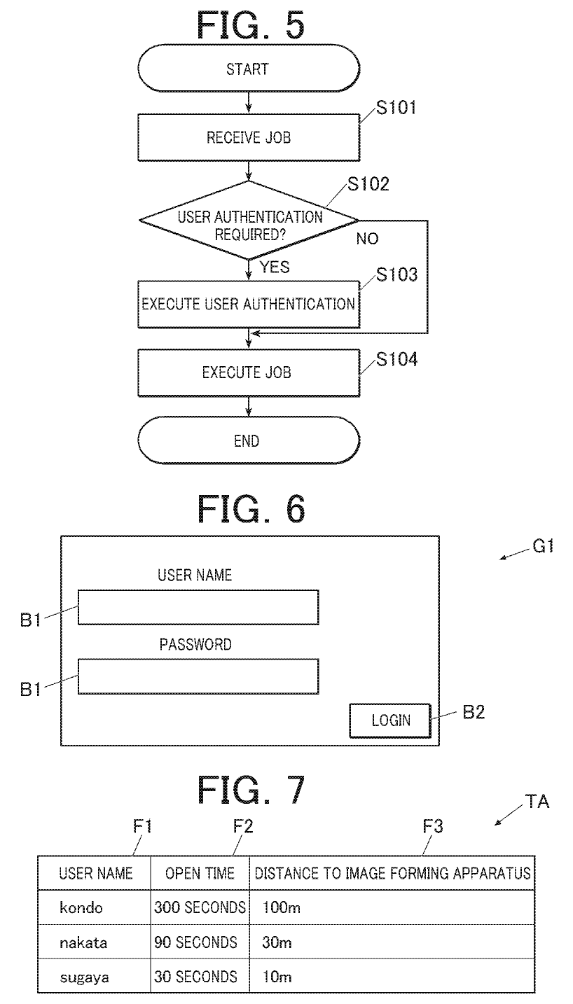

Next, the control of the image forming system 1 according to the present embodiment will be described with reference to the flowchart of FIG. 5.

First, the controller 21 receives a job submitted from the terminal device 10 (step S101). Thereafter, the user moves to the image forming apparatus 20 and performs, via the operation part 252, a first input (e.g., pressing a start button) that leads to an execution instruction of a job. This causes an authentication screen to be displayed on the display part 251. FIG. 6 illustrates an example of the authentication screen G1. As illustrated in FIG. 6, the authentication screen G1 includes input fields B1 for user name and password, and a login button B2. In the authentication screen G1, the user enters a user name and a password in the respective input fields B1 and presses the login button B2, thereby performing user authentication.

Next, the controller 21 determines whether user authentication is required (step S102). Specifically, the controller 21 determines whether authentication based on a second input from the user is required based on the time from submission of a job from the terminal device 10 to reception of the first input leading to the execution instruction of the job. That is, the controller 21 functions as a determination section of the present disclosure. Here, the second input from the user is input of a user name and a password.

For example, when the time until the first input leading to the execution instruction of the job is received is within a first predetermined time, the controller 21 determines that authentication is not required. Here, the first predetermined time is a time sufficient to consider the user who has performed the first input to be the user who has submitted the job from the terminal device 10, and is, for example, 180 seconds.

For example, the first predetermined time may be a time set for each user. FIG. 7 shows an example of a table TA in which the first predetermined time is set for each user.

The table TA includes fields for user name F1, open time F2, and distance F3 to the image forming apparatus. Here, the open time F2 is the first predetermined time. The distance F3 to the image forming apparatus is the distance between the terminal device 10 assigned to each user and the image forming apparatus 20. For example, in the first record, the user name F1 is "kondo", the open time F2 is "300 seconds", and the distance F3 to the image forming apparatus is “100 m". That is, the first record indicates that the open time F2 for the user name F1 "kondo" is "300 seconds" and the distance F3 to the image forming apparatus is “100 m".

As illustrated in FIG. 7, the controller 21 may calculate the first predetermined time based on the distance between the terminal device 10 assigned to the user and the apparatus itself (the image forming apparatus 20). In this case, the distance (radio field intensity) between the terminal device 10 assigned to the user and the image forming apparatus 20 is measured using a communication means (Bluetooth or the like) to calculate the first predetermined time.

If the controller 21 determines that user authentication is required (step S102: YES), the controller 21 advances the processing to the next step S103. In this step, the authentication screen G1 illustrated in FIG. 6 is displayed as it is.

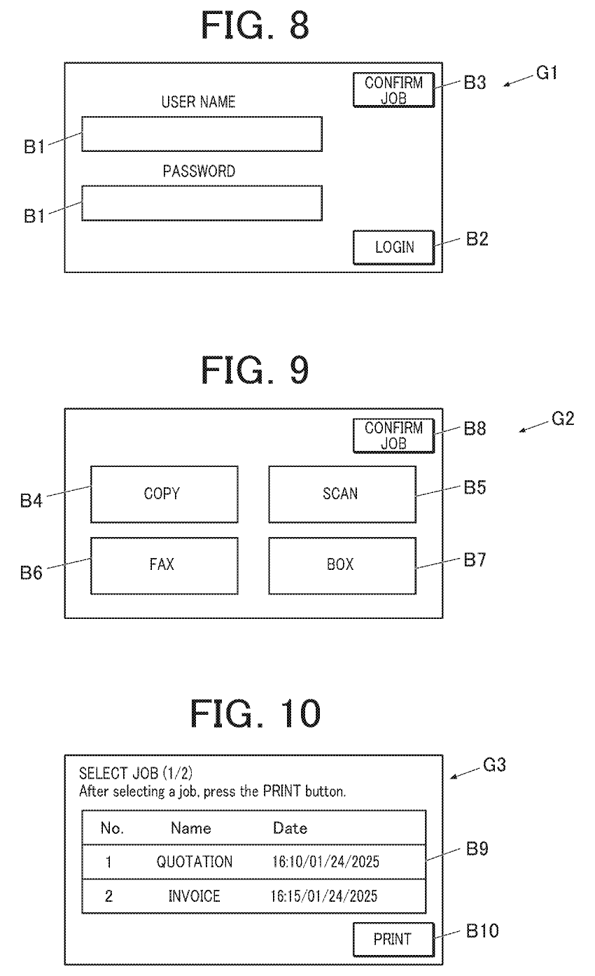

On the other hand, if the controller 21 determines that user authentication is not required (step S102: NO), the controller 21 advances the processing to step S104. In this step, a job confirmation button B3 is newly displayed in the upper right portion of the authentication screen G1 (see FIG. 8). That is, on the authentication screen G1, the job confirmation button B3 is temporarily activated and becomes inactive after a predetermined time elapses. When the job confirmation button B3 is pressed by the user, a job execution screen G3 (see FIG. 10) is displayed without inputting a user name and a password.

In step S103, the controller 21 executes user authentication. To be specific, the controller 21 compares the content (the user name and the password) of the second input performed by the user on the authentication screen G1 with authentication information (the user name and the password) registered in advance in the image forming apparatus 20 to perform authentication determination. If the controller 21 determines that the authentication is OK, the controller 21 allows a home screen G2 (see FIG. 9) to be displayed. If the controller 21 determines that the authentication is not OK, the controller 21 causes a message indicating that the authentication has failed to be displayed on the authentication screen G1 and repeats the processing in step S103 until the controller 21 determines that the authentication is OK.

FIG. 9 illustrates an example of the home screen G2. As illustrated in FIG. 9, the home screen G2 includes a copy button B4, a scan button B5, a fax button B6, and a box button B7. The copy button B4 is a button for using a copy function. The scan button B5 is a button for using a scan function. The fax button B6 is a button for using a fax function. The box button B7 is a button for using a box function. Further, a job confirmation button B8 is provided in the upper right portion of the home screen G2. When the job confirmation button B8 is pressed by the user, the job execution screen G3 (see FIG. 10) is displayed.

FIG. 10 illustrates an example of the job execution screen G3. As illustrated in FIG. 10, the job execution screen G3 includes a job list display region B9 and a print button B10. The job list display region B9 is a region in which a list of jobs received by the image forming apparatus 20 is displayed. On the job execution screen G3, the user can select his/her job from the job list displayed in the job list display region B9 and press the print button B10 to instruct execution of his/her job. That is, the controller 21 functions as a reception section of the present disclosure that receives an execution instruction of a job (pressing of the print button B10) submitted from the terminal device 10. When the print button B10 is pressed on the job execution screen G3, the controller 21 advances the processing to step S104.

In step S104, the controller 21 executes the job. To be specific, the controller 21 executes the job selected by the user on the job execution screen G3. That is, the controller 21 functions as an execution section of the present disclosure that executes a job based on the received execution instruction of the job.

If the controller 21 determines in step S102 that the authentication is required, the controller 21 executes the job after executing the authentication.

On the other hand, if the controller 21 determines in step S102 that the authentication is not required, the controller 21 executes the job without executing the authentication.

As described above, the job execution apparatus (the image forming apparatus 20) according to the present embodiment includes the reception section (the controller 21), the determination section (the controller 21), and the execution section (the controller 21). The reception section receives an execution instruction of a job submitted from an external device (terminal device 10). The determination section determines, based on the time from submission of a job from the terminal device to reception of the first input leading to the execution instruction of the job, whether authentication based on the second input from the user is required. The execution section executes the job based on the execution instruction of the job received by the reception section. When the determination section determines that the authentication is required, the execution section executes the job after executing the authentication. When the determination section determines that the authentication is not required, the execution section executes the job without executing the authentication.

Therefore, it is possible to dynamically change the necessity of user authentication according to the elapsed time since job submission. For example, a job to be executed within a predetermined time after job submission is highly likely to be initiated by the user himself/herself, so that authentication is omitted. This allows for the simultaneous achievement of security assurance and improved convenience. That is, security can be guaranteed even for users who seek convenience without basically performing authentication.

When the time is within the first predetermined time, the determination section determines that authentication is not required.

For example, a job to be executed within a predetermined time after job submission is highly likely to be initiated by the user himself/herself, so that authentication can be omitted. This allows for the simultaneous achievement of security assurance and improved convenience.

The first predetermined time is a time set for each user.

Therefore, taking into account the differences among users, the reference time for determining that the authentication is not required can be set appropriately. The differences among users are, for example, a distance between the image forming apparatus 20 and his/her seat, a behavior pattern, and the like. Therefore, it is possible to more reliably achieve both the security assurance and the improved convenience.

The first predetermined time is calculated based on the distance between the external device assigned to the user and the image forming apparatus 20.

Therefore, taking into account the timing at which each user arrives at the image forming apparatus 20, the reference time for determining that authentication is not required can be set appropriately. Therefore, it is possible to more reliably achieve both the security assurance and the improved convenience.

Although specific description has been given above based on the embodiment according to the present disclosure, the present disclosure is not limited to the above-described embodiment, and changes can be made without departing from the spirit and scope of the present disclosure.

### Modification Example 1

For example, in the above-described embodiment, a configuration in which input of a user name and a password is required for user authentication (see FIG. 6 and the like) has been described as an example, but the present invention is not limited thereto. For example, a PIN code may be required to be input instead of a user name and a password.

In Modification Example 1 in which the input of a PIN code is required, first, the controller 21 receives a job submitted from the terminal device 10 (see step S101 in FIG. 5). Thereafter, the user moves to the image forming apparatus 20 and presses the start button via the operation part 252. This causes the job execution screen G3 to be displayed on the display part 251 (see FIG. 10). On the job execution screen G3, the user can select his/her job from the job list displayed in the job list display region B9 and press the print button B10 to instruct execution of the job.

When the print button B10 is pressed on the job execution screen G3, the controller 21 determines whether user authentication is required (see step S102 in FIG. 5). Specifically, the controller 21 determines whether authentication based on a second input from the user is required based on the time from submission of a job from the terminal device 10 to reception of the first input leading to the execution instruction of the job. Here, the first input leading to the execution instruction of the job is pressing of the print button B10.

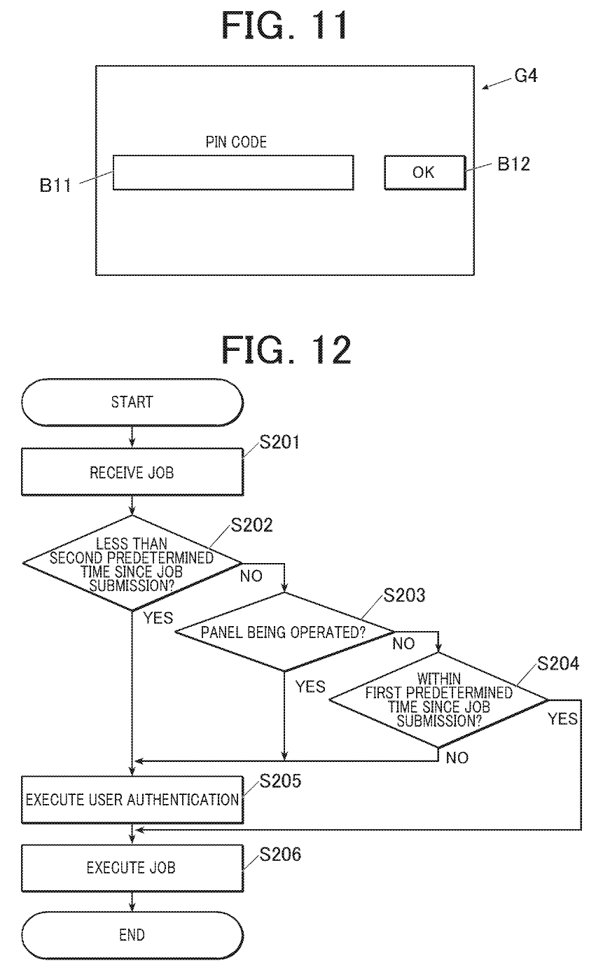

If the controller 21 determines that user authentication is required (step S102: YES), the controller 21 causes a PIN code input screen to be displayed. FIG. 11 illustrates an example of the PIN code input screen G4. As illustrated in FIG. 11, the PIN code input screen G4 includes an input field B11 for a PIN code and an OK button B12. On the PIN code input screen G4, the user inputs a PIN code in the input field B11 and presses the OK button B12, thereby performing user authentication. Thereafter, the controller 21 executes user authentication (see step S103 in FIG. 5). To be specific, the controller 21 compares the content (PIN code) of the second input performed by the user in the PIN code input screen G4 with the authentication information (PIN code) set for the selected job to perform authentication determination. If the controller 21 determines that the authentication is OK, the controller 21 executes the job selected by the user on the job execution screen G3 (see step S104 in FIG. 5). If the controller 21 determines that authentication is not OK, the controller 21 causes a message indicating that authentication has failed to be displayed on the PIN code input screen G4 and repeats the user authentication processing until the controller 21 determines that the authentication is OK.

On the other hand, if the controller 21 determines that user authentication is not required (step S102: NO), the controller 21 executes the job selected by the user on the job execution screen G3 without displaying the PIN code input screen G4 (see step S104 in FIG. 5).

As described above, the present disclosure can also be applied to a configuration in which input of a PIN code is required as user authentication.

Note that authentication in the present disclosure is not limited to ID/password authentication and authentication using a PIN code set for a job. For example, the authentication may be card authentication.

### Modification Example 2

Furthermore, the controller 21 may determine that authentication is required when the time from job submission is less than a second predetermined time, which is shorter than the first predetermined time. Here, the second predetermined time is a period deemed sufficient for the user who has submitted the job from the terminal device 10 to reach the image forming apparatus 20, such as 15 seconds.

Furthermore, when a job is submitted from the terminal device 10 while a panel operation is being performed, the controller 21 may determine that authentication is required.

Next, the control of the image forming system 1 according to Modification Example 2 will be described with reference to the flowchart of FIG. 12.

First, the controller 21 receives a job submitted from the terminal device 10 (step S201).

Next, the controller 21 determines whether the time from job submission is less than the second predetermined time (step S202).

If the controller 21 determines that the time from job submission is less than the second predetermined time (step S202: YES), the controller 21 advances the processing to step S205.

On the other hand, if the controller 21 determines that the time from job submission is equal to or greater than the second predetermined time (step S202: NO), the controller 21 advances the processing to the next step S203.

In step S203, the controller 21 determines whether a panel operation (operation on the operation panel 25) is being performed.

If the controller 21 determines that a panel operation is being performed (step S203: YES), the controller 21 advances the processing to step S205.

On the other hand, if the controller 21 determines that a panel operation is not being performed (step S203: NO), the controller 21 advances the processing to the next step S204.

In step S204, the controller 21 determines whether the time from job submission is within the first predetermined time.

If the controller 21 determines that the time from job submission is within the first predetermined time (step S204: YES), the controller 21 advances the processing to step S206.

On the other hand, if the controller 21 determines that the time from job submission exceeds the first predetermined time (step S204: NO), the controller 21 advances the processing to the next step S205.

In step S205, the controller 21 executes user authentication. Thereafter, the controller 21 advances the processing to step S206.

In step S206, the controller 21 executes the job.

As described above, when the time from submission of a job from the external device is less than the second predetermined time, which is shorter than the first predetermined time, the determination section determines that authentication is required.

For example, a job to be executed in less than the second predetermined time after job submission (immediately after job submission) is highly likely to be initiated by someone other than the intended user, so that authentication can be enforced. Therefore, it is possible to more reliably achieve both the security assurance and the improved convenience.

Furthermore, when a job is submitted from the external device while a panel operation is being performed, the determination section determines that authentication is required.

Therefore, since the user operating the panel during job submission is highly likely to be someone other than the user who has submitted the job, authentication can be enforced. Therefore, it is possible to more reliably achieve both the security assurance and the improved convenience.

### Modification Example 3

Furthermore, when jobs have been submitted from a plurality of different users within the first predetermined time, the controller 21 may determine that authentication is required.

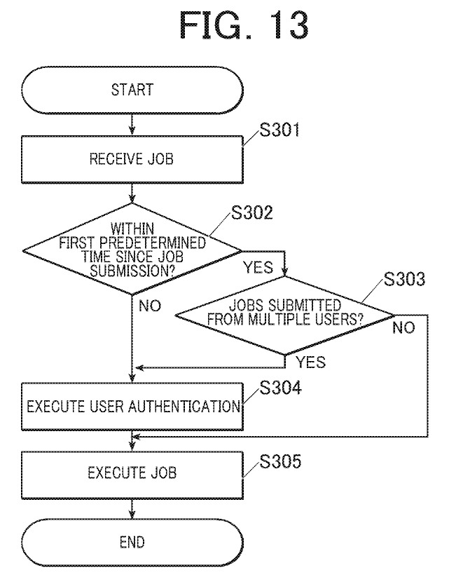

Next, the control of the image forming system 1 according to Modification Example 3 will be described with reference to the flowchart of FIG. 13.

First, the controller 21 receives a job submitted from the terminal device 10 (step S301).

Next, the controller 21 determines whether the time from job submission is within the first predetermined time (step S302).

If the controller 21 determines that the time from job submission is within the first predetermined time (step S302: YES), the controller 21 advances the processing to the next step S303.

On the other hand, if the controller 21 determines that the time from job submission exceeds the first predetermined time (step S302: NO), the controller 21 advances the processing to step S304.

In step S303, the controller 21 determines whether jobs have been submitted from a plurality of different users.

If the controller 21 determines that jobs have been submitted from a plurality of different users (step S303: YES), the controller 21 advances the processing to the next step S304.

If the controller 21 determines that jobs have not been submitted from a plurality of different users (step S303: NO), the controller 21 advances the processing to step S305.

In step S304, the controller 21 executes user authentication. Thereafter, the controller 21 advances the processing to step S305.

In step S305, the controller 21 executes the job.

As described above, when jobs have been submitted from a plurality of different users within the first predetermined time, the determination section determines that authentication is required.

That is, when there is a high risk of printed materials being mistakenly taken by others due to accumulated jobs from a plurality of different users, authentication can be enforced. Therefore, it is possible to more reliably achieve both the security assurance and the improved convenience.

Further, in the above-described embodiments, the electrophotographic image forming apparatus has been described as an example, but the present invention is not limited thereto. For example, it is also possible to apply the present disclosure to an image forming apparatus of an inkjet system that records an image on a sheet by ejecting ink from nozzles onto the sheet and landing the ink in a desired pattern. The image forming apparatus of the inkjet system, for example, ejects ink that is cured by a predetermined energy ray from nozzles and irradiates the ejected ink on a sheet with the predetermined energy ray to cure the ink, thereby fixing the ink on the sheet.

Besides, the detailed configuration of each device constituting the image forming system and the detailed operation of each device can also be appropriately modified without departing from the spirit and scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. A job execution apparatus comprising a hardware processor that:
receives an execution instruction of a job submitted from an external device;
determines, based on a time from submission of the job from the external device to reception of a first input from a user, the first input leading to the execution instruction of the job, whether authentication based on a second input from the user is required; and
executes the job based on the received execution instruction of the job, wherein,
when determining that the authentication is required, the hardware processor executes the job after executing the authentication, and,
when determining that the authentication is not required, the hardware processor executes the job without executing the authentication.

2. The job execution apparatus according to claim 1, wherein, when the time is within a first predetermined time, the hardware processor determines that the authentication is not required.

3. The job execution apparatus according to claim 1, wherein the authentication includes ID/password authentication, card authentication, and authentication using a PIN code set for the job.

4. The job execution apparatus according to claim 2, wherein the first predetermined time is a time set for each user.

5. The job execution apparatus according to claim 4, wherein the first predetermined time is calculated based on a distance between the external device assigned to the user and the job execution apparatus.

6. The job execution apparatus according to claim 2, wherein, when the time from the submission of the job from the external device is less than a second predetermined time, the hardware processor determines that the authentication is required, the second predetermined time being shorter than the first predetermined time.

7. The job execution apparatus according to claim 2, wherein, when the job is submitted from the external device while a panel operation is being performed, the hardware processor determines that the authentication is required.

8. The job execution apparatus according to claim 2, wherein
the user includes a plurality of different users,
the job includes a plurality of jobs, and,
when the plurality of jobs is submitted from the plurality of different users within the first predetermined time, the hardware processor determines that the authentication is required.

9. A job execution method executed by a job execution apparatus, comprising:
receiving an execution instruction of a job submitted from an external device;
determining, based on a time from submission of the job from the external device to reception of a first input from a user, the first input leading to the execution instruction of the job, whether authentication based on a second input from the user is required; and
executing the job based on the execution instruction of the job received in the receiving, wherein,
when the authentication is determined to be required in the determining, the executing includes executing the job after executing the authentication, and,
when the authentication is determined not to be required in the determining, the executing includes executing the job without executing the authentication.

10. A non-transitory computer-readable storage medium storing a program that causes a computer of a job execution apparatus to function as:
a reception section that receives an execution instruction of a job submitted from an external device;
a determination section that determines, based on a time from submission of the job from the external device to reception of a first input from a user, the first input leading to the execution instruction of the job, whether authentication based on a second input from the user is required; and
an execution section that executes the job based on the execution instruction of the job received by the reception section, wherein,
when the determination section determines that the authentication is required, the execution section executes the job after executing the authentication, and,
when the determination section determines that the authentication is not required, the execution section executes the job without executing the authentication.
